(19) United States
(12) Patent Application Publication
(10) Pub. No.: US 2012/0310822 A1
(43) Pub. Date: Dec. 6, 2012

(54) AGGREGATING DEBT TO INCREASE BARGAINING POWER

(76) Inventor: ELIZABETH NEGA, LIBERTY LAKE, WA (US)

(21) Appl. No.: 13/489,929

(22) Filed: Jun. 6, 2012

Related U.S. Application Data
(60) Provisional application No. 61/493,639, filed on Jun. 6, 2011.

(51) Int. Cl. G06Q 40/00

(52) U.S. Cl. 705/39; 705/35

(57) ABSTRACT

Systems and methods for aggregating debt to increase bargaining power are provided. An example system includes a web-based aggregating service that enlists subscribers or participants. The service compiles multiple individual debts owed to one creditor by numerous participating members into an aggregated debt with which to approach the creditor for negotiation of a discounted payment. The payment is attractive and relatively reduced from the standpoint of the debtors because it is discounted. Since the discount is applied to numerous debts that are to be resolved in a relatively short timeframe, the payment is attractive, paid quickly, and relatively increased from the standpoint of the creditor, compared with conventional individual collections, which are relatively expensive and have a poor success rate.

### RELATED APPLICATIONS

This application claims the benefit of priority to U.S. Provisional Patent Application No. 61/493,639 to Nega, filed Jun. 6, 2011 and incorporated herein by reference in its entirety.

### BACKGROUND

Debt can create an unpleasant impasse for both debtor and creditor. Most often, when a debtor does not pay, it is because the debtor cannot pay the face value of the debt within a time frame set by the creditor. Attempts on the part of the creditor to collect the debt are typically expensive and prone to a low success rate, since often the debtor does not have the means to pay the debt, or else the debtor would have already made payment.

Medical debt, for example, represents a growing problem during recessionary times, as insurance companies and governments also add to the problem by modifying the playing field for medical services providers and for clients of these services. It is estimated that 62% of consumer bankruptcies involve medical debt, where the consumer already had medical insurance. This massive loss of payment monies, in turn, causes the medical services providers to increase prices, a vicious circle, and often to experience an emergency in their own finances.

### SUMMARY

Systems and methods for aggregating debt to increase bargaining power are provided. An example system includes a web-based aggregating service that enlists subscribers or participants. The service compiles multiple individual debts owed to one creditor by numerous participating members into an aggregated debt with which to approach the creditor for negotiation of a conditional, discounted payment. Since the discount is applied to numerous debts that are to be resolved in a relatively short timeframe, the payment is relatively large, paid quickly, and attractive to the creditor compared with conventional individual collections, which are relatively expensive and have a poor success rate.

The conditional payments include discounts based on the total dollar amount of the creditors' accounts receivable that the aggregated debtors commit to settle in a specified and limited time period. The example system facilitates “debtor-driven payments” that aggregate the desire of existing debtors who may or may not know each other to pay outstanding bills owed to creditors at a discounted rate. The example system allows debtors acting as a group, even when the debtors may not have any formal relationship with each other, to conveniently negotiate debtor-driven discounts. In one implementation, the discount increases as the amount of the creditor's accounts receivable being settled by a specified date increases.

This summary section is not intended to give a full description of systems and methods for aggregating debt to increase bargaining power, or to provide a comprehensive list of features and elements. A detailed description with example implementations follows.

### BRIEF DESCRIPTION OF THE DRAWINGS

FIG. 1 is a block diagram of an example system for aggregating debt to increase bargaining power.

FIG. 2 is a block diagram of an example debt aggregation process.

FIGS. 3-4 are an operational flow diagram of an example web page for applying for debt aggregation.

FIG. 5 is an operational flow diagram of an example web page for applying for an optional consumer loan associated with a type of debt.

FIG. 6 is a flow diagram of an example method of aggregating debt.

### DETAILED DESCRIPTION

Overview

This disclosure describes systems and methods for aggregating debtors to increase bargaining power. An example system aggregates participating debtors in order to negotiate significant group discounts from creditors that the debtors may have in common. From the standpoint of the creditor, the example system aggregates accounts receivable and improves collections. The discount may increase (e.g., a discount of 30-50%) as the magnitude of the total payment to a creditor increases due to the number of debt payments being aggregated. In one implementation used as a representative example, a system aggregates self-pay medical clients who carry ongoing financial obligations in order to negotiate group discounts from one or more medical providers.

The enlistment or recruitment of participating debtors, the multiplex aggregation of the debtors under multiple creditors, and the negotiation of the discounts, may be carried out by a service, such as a web-based service. In one implementation, the service enlists debtors as members, under a subscription, and receives a percentage of collections from the creditors (e.g., in the case of medical debt, the creditors may be providers, such as hospitals or physician offices). In one implementation, the service also receives a percentage of the discount from debtor members and/or receives a subscription fee.

Example System

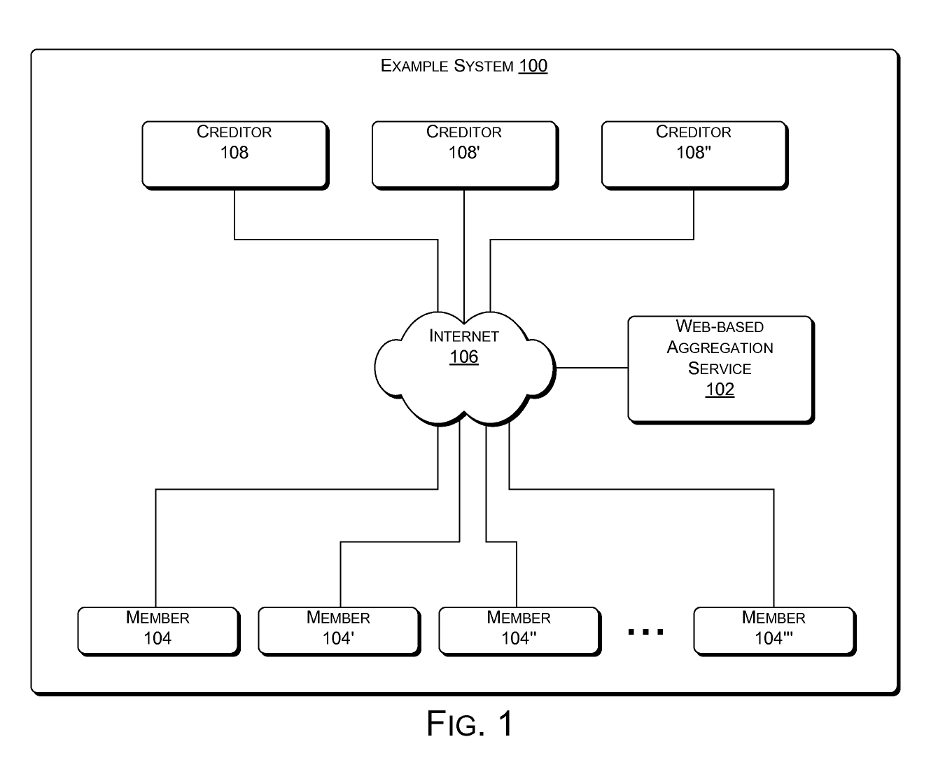

FIG. 1 shows an example system 100, in which an example web-based aggregation service 102 (hereinafter “service” 102) enlists members 104 via the Internet 106 or other medium as participants or subscribers. Members 104 typically have access to the Internet 106 and the service 102 through client computing devices. The service 102 then communicates with creditors 108 on behalf of strategic groups of the members 104. The service 102 may advocate or negotiate on behalf of the members 104, strategically aggregating debt from the members 104 to obtain a certain level of discount for the members 104 while obtaining a certain level of payment for the creditors 108 across multiple members 104.

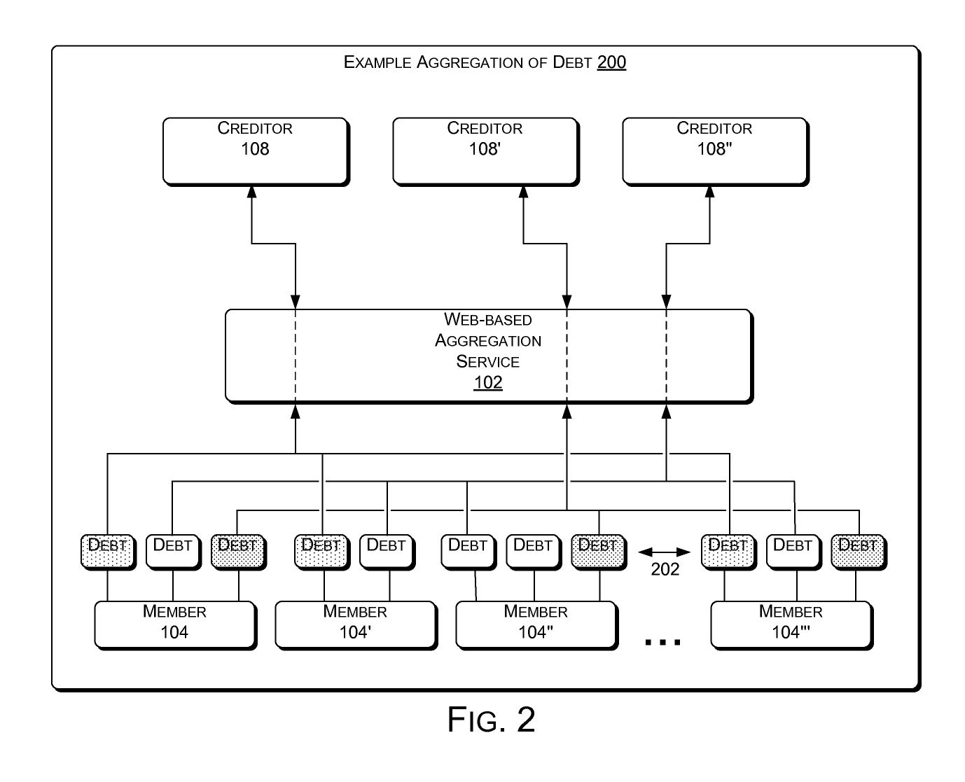

FIG. 2 shows an example process of debt aggregation 200 by the service 102. Each member 104 may have various debts 202. A member 104 may have multiple debts owed to multiple different creditors 108. The service 102 compiles multiple individual debts owed to one creditor 108 across multiple members 104, and packages the multiple individual debts into an aggregated debt, with which to approach the corresponding creditor 108 for negotiation and conditional offers of settlement and resolution. A given creditor 108 may or may not contract with the service 102. Hence, in one implementation, the service 102 aggregates debt from numerous members 104 before approaching the creditor 108 to form a contract with the service 102 and/or a contract between the creditor 108 and the members 104. Likewise, in one implementation, the service 102 obtains a settlement between a creditor 108 and the relevant members 104, without entering into a contract with the creditor 108, while in another implementation, the service 102 obtains the settlement while also entering into a contract with the given creditor 108.

Example Implementation

This example uses a medical setting as a representative scenario. Individuals or individual entities that owe and desire to negotiate self-pay medical bills (e.g., outstanding uninsured payments and commercial co-pays) may submit invoice information including amounts owed and provider (creditor 108) identification to the example service 102. The service 102 aggregates proposed payments with other debtors' proposed payments to the same creditor(2) 108. A duration for aggregation of proposed payments is set (e.g., two weeks).

In one implementation, once aggregate amounts exceed a targeted size (e.g., above $2 million dollars), the service 102 may approaches the provider(s) with the proposed aggregate payment(s) and offers (on behalf of the debtors) to pay a discounted amount of the total (e.g., 30-50%). The size of the discount can be based on the size of the aggregate proposed payments. In one scheme, the greater the amount of proposed payment the greater the discount.

In one implementation, to receive the discount all debtors or a certain percentage of debtors in the group commit beforehand to paying the discounted amount as soon as the duration for aggregation expires (assuming the provider has accepted to receive the discounted payment). No payment may be due if the service 102 fails to aggregate enough debtors to exceed a targeted level of proposed aggregate payment, for example, or fails to negotiate a discount from providers.

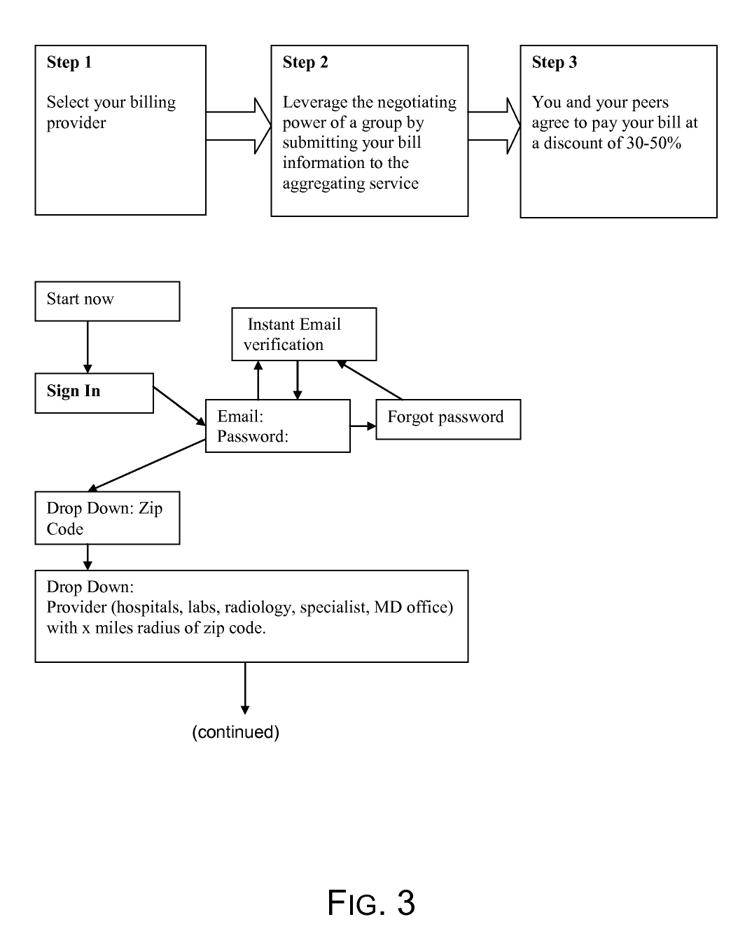

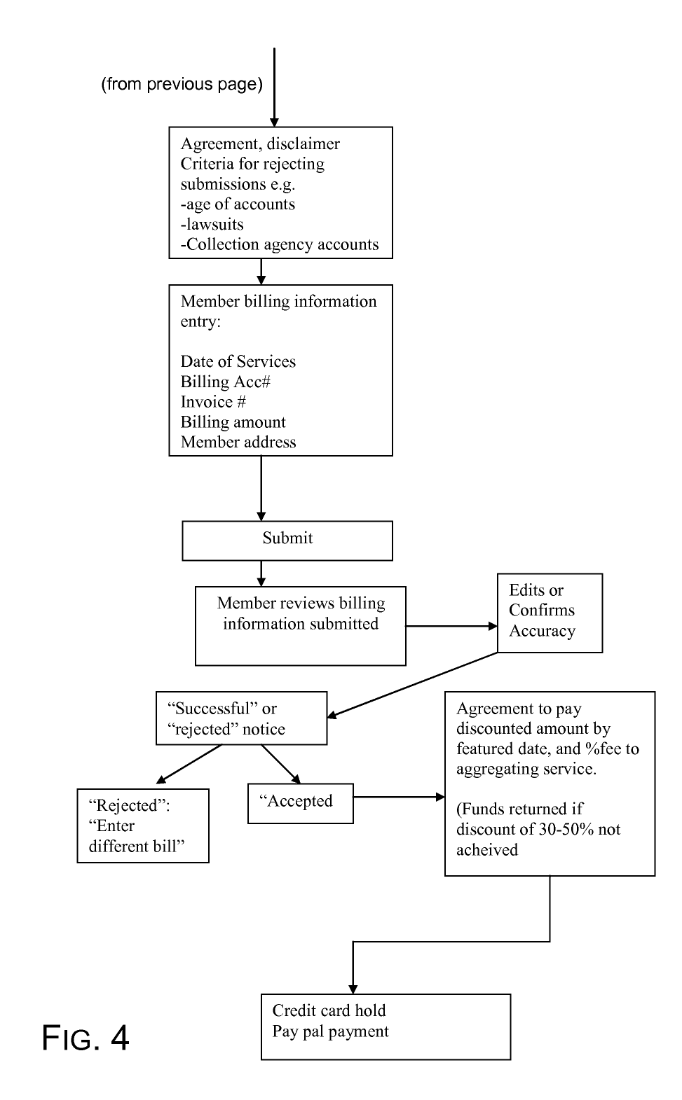

FIGS. 3-4 show an example web page flow for applying for debt aggregation. An example web page may also display summaries, such as total dollars saved, total bills paid, and awards made. A time display may show the remaining time or days until the closure of the member's particular deal.

Variations

In one implementation, an optional “frequent payer award” provides points (much like frequent flyer miles) for using the service 102 frequently. Or, in a related implementation, the service 102 additionally provides consumer loans, and points may be awarded for diligent payment of a consumer loan. These points can also be redeemed to pay medical bills or other bills.

In one implementation, the service 102 offers a “pay for peer” award scheme, in which a group of successful debtors donates a percentage of the discount toward payment of the bills of one individual or family selected per month (e.g., a vulnerable recipient, or a random lottery recipient. In one implementation, the group of debtors votes on recipients to receive the award.

In an implementation, the service 102 provides an increase in bargaining power by aggregating purchasers of medical procedures and diagnostic tests. Such an example system includes a web-based aggregating service that enlists subscribers or participants. The service combines one or more individual planned procedures desired by one purchaser with procedures of numerous participating members into an aggregated purchasing group, which approaches the provider organization to negotiate a discounted price. Since the purchasing group is relatively large, it is attractive to the provider organization compared with conventional individual purchases of medical procedures. The negotiated price-per-procedure includes discounts based on the total number of tests or procedures to be purchased. The example system aggregates the desire of existing purchasers who may or may not know each other to purchase medical procedures and diagnostic tests from provider organizations at a discounted rate. The example system allows purchasers acting as a group, even when the purchasers may not have any formal relationship with each other, to conveniently negotiate group purchasing-driven discounts.

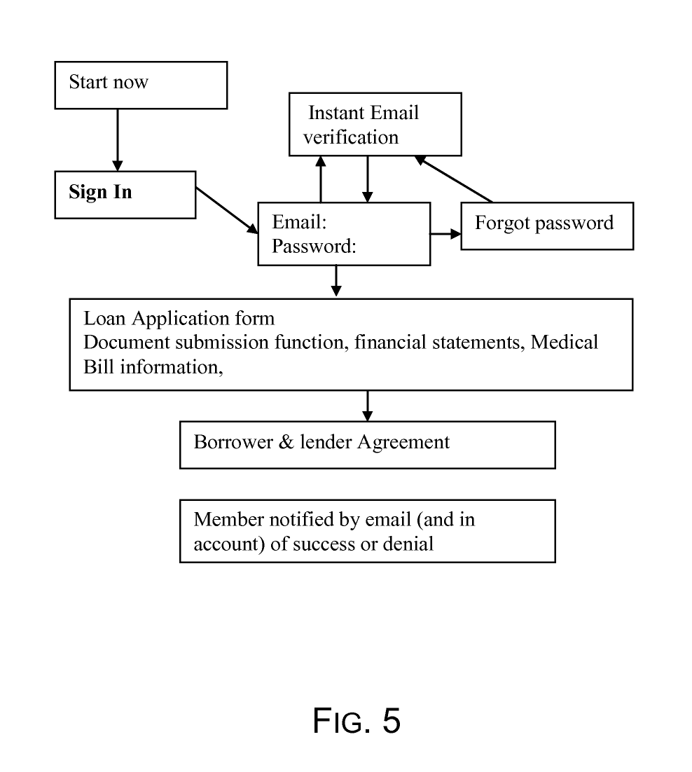

The service 102 may offer an optional consumer loan service for payment of medical bills. FIG. 5 shows an example web page flow for applying for an optional consumer loan associated with a type of debt. An explanation of the loan amounts (for example, less than $5000), criteria (credit scores etc), how loans are administered and paid, and so forth, may be shown.

Thus, the example service 102 may provide multidimensional assistance to members 104. The service 102 can provide aggregated payment power for gaining discounts on bills owned, together with additional services such as financial counseling, health counseling, consumer loans, and so forth. The service 102 may provide a discussion forum, explanation of benefits section, drop-down menus with categories for members 104 to select their most common frequently-asked-questions (FAQ) topics and to submit questions. In an articles section, an expert (e.g., benefits lawyer) may write an article on the highest volume topic, for example, each week.

A web log (blog) for community discussion regarding bills, insurance companies, providers, etc., may be provided.

An awards program may provide points for dollars paid through the service 102, the points applicable to payment of future bills. The service 102 may administer donation of payment of bills for needy persons, providing application forms. Candidates may be voted on by other members, for example.

Example Method

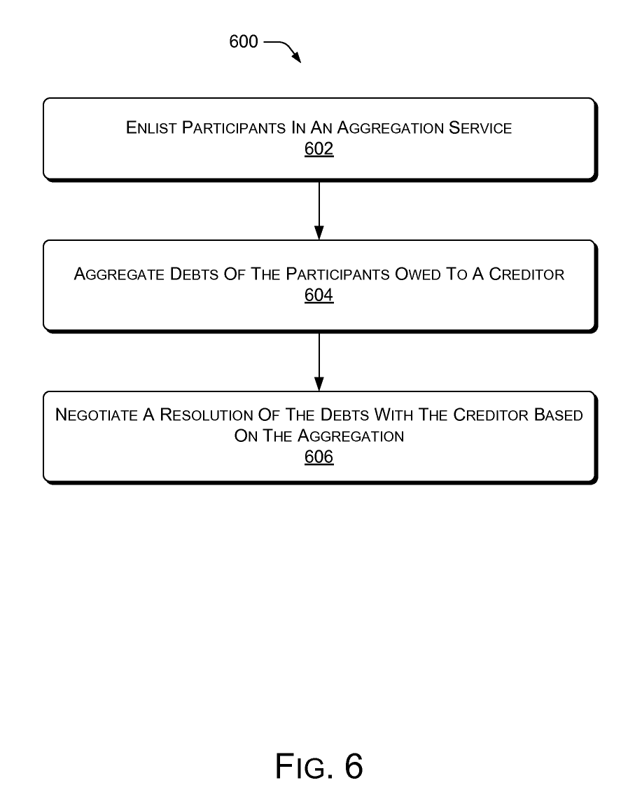

FIG. 6 shows an example method 600 of aggregating debt. In the flow diagram, the operations are summarized in individual blocks. The example method 600 may be performed by hardware or combinations of hardware and software, for example, by the example system 100 and service 102. The software may consist of instructions contained in a computer-readable storage medium. When read by a device, the instructions cause the computer to perform some or all of the example method 600.

At block 602, participants are enlisted in a debt aggregation service.

At block 604, debts of the participants owed to a creditor are aggregated.

At block 606, a resolution of the debts is negotiated based on the aggregation.

Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. (canceled)

2. A method, comprising:
enlisting participants in a debt aggregating service;
aggregating debts of the participants owed to a creditor; and
negotiating a resolution of the aggregated debts with the creditor.

3. The method of claim 2, wherein the resolution is based on a degree of the aggregation.

4. The method of claim 2, wherein the resolution is based on a discount of a payment to resolve the aggregated debt, the discount based on a magnitude of a payment for the aggregated debt.

5. The method of claim 2, wherein the resolution is based on a discount of a payment to resolve the aggregated debt, the discount based on a time period in which payment of the aggregated debt is made.

6. A system for aggregating debtors who may or may not know each other and who desire to pay bills at a discounted rate owed to at least one creditor and for the elimination of debt by a plurality of individual debtors.

7. The system of claim 6, further comprising a service to communicatively couple with creditors and members of the service.

8. The system of claim 7, wherein the service transmits prior to the beginning of a specified and limited time period, to said creditor, a conditional payment, the conditional payment offer specifying levels of discount based on the total amount of the creditor's accounts receivable that the aggregated debtors commit to settle in the specified and limited time period.

9. The system of claim 7, further comprising web pages to display the conditional payment offer;
a plurality of individual debtor devices to communicate with the service whereby said plurality of individual debtors can indicate to the service an acceptance of the discounted payment offer to be paid to the creditor.

10. The system of claim 9, wherein the service negotiates the discount with the creditor based on the conditional payment offer and an aggregate amount of the payment to the creditor that the plurality of individual debtors have collectively indicated a willingness to pay during the specified and limited time period.

11. The system of claim 2, operating in accordance with the specified and limited time period, wherein payment of debts to a particular creditor are only accepted for the specified and limited time period.

12. The system of claim 11, wherein the service makes available the conditional payment offer and discount amount to a plurality of web sites.

13. The system recited of claim 2, wherein the conditional payment offer includes different discounts for different quantities of payments.

14. The system of claim 2, wherein the service provides a system for communicating conditional discounted payment offers from the creditors to a plurality of individual potential debtors.

15. The system of claim 14, wherein the service receives a commission on the payment collected by the creditors from plurality of individual potential debtors.

16. The system of claim 14, wherein the conditional payment offer is displayed on web sites operated by site operators, and wherein the service and the site operators receive a commission on the discount received by the plurality of individual potential debtors.

17. A computer-readable storage medium, containing instructions, which when executed by a computer perform a process, comprising:
enlisting participants in a debt aggregating service;
aggregating debts of the participants owed to a creditor; and
negotiating a resolution of the aggregated debts with the creditor.
